(19) United States
(12) Patent Application Publication
(10) Pub. No.: US 2005/0236991 A1
(43) Pub. Date: Oct. 27, 2005

(54) Plasma display panel and method of fabricating the same

(76) Inventor: Jung-Suk Song, Suwon-si (KR)

Correspondence Address: MCGUIREWOODS, LLP, 1750 TYSONS BLVD, SUITE 1800, MCLEAN, VA, 22102, US

(21) Appl. No.: 11/109,799

(22) Filed: Apr. 20, 2005

(30) Foreign Application Priority Data
Apr. 21, 2004 (KR) 10-2004-0027564

(51) Int. Cl. H01J 17/49; H01J 9/00

(52) U.S. Cl. 313/582; 445/24

(57) ABSTRACT

A plasma display panel and a method of fabricating the plasma display panel are disclosed where a barrier rib is formed with a multi-layered structure by performing at least two etching processes on a substrate.

### CROSS REFERENCE TO RELATED APPLICATION

This application claims priority to and the benefit of Korean Patent Application No. 10-2004-0027564, filed on Apr. 21, 2004, which is hereby incorporated by reference for all purposes as if fully set forth herein.

### BACKGROUND OF THE INVENTION

1. Field of the Invention

The present invention relates to a plasma display panel having an improved barrier rib structure and a method of fabricating the plasma display panel.

2. Discussion of the Background

Generally, a plasma display panel (PDP) displays images through a gas discharge, which emits ultraviolet rays that excite a phosphor layer to emit visible light.

The PDP includes front and rear substrates, a plurality of discharge electrodes formed on a surface of the front substrate, barrier ribs formed on a surface of the rear substrate to is define discharge cells, and a phosphor layer coated in the discharge cells.

Here, the barrier ribs may be fabricated by washing the substrate, depositing a raw material for forming the barrier ribs on the substrate, drying the substrate, exposing and developing a photomask, sand blasting the raw material at regions where the barrier ribs are not to be formed, removing the remaining photoresist layer, and baking the remaining raw material.

In such a conventional barrier rib fabrication process, the sand blasting may include blasting an abrasive material such as CaCO₃ onto the substrate at high pressure, thereby forming fine recesses on the substrate.

Accordingly, the raw material may be applied onto the substrate and the photoresist is formed thereon. The photoresist is then exposed and developed, and an etchant is injected onto the photoresist to form the barrier ribs. This method may be referred to as an etching method.

Korean Laid-open Patent No. 2000-13228 discloses a barrier rib that is higher than it is wide by performing the etching process after forming a recess on the substrate. Korean Laid-open Patent No. 1993-8917 discloses a barrier rib formed by directly etching the substrate.

The barrier rib may be formed through the following processes according to the conventional etching method.

A discharge electrode is formed on a substrate, a dielectric layer is formed covering the discharge electrode, and a raw material for forming the barrier rib is formed on the dielectric layer. Next, a photoresist is applied on the raw material and exposed and developed. Unnecessary portions of the raw material may then be etched away to form the desired barrier ribs.

However, the barrier ribs fabricated with the etching method may have a biconcave cross section where the barrier rib's top and bottom portions are wider than its center. This structure may be generated by an under cut problem caused by an isotropic etching speed during the etching process, whereby the etchant etches the raw material in vertical and horizontal directions. In other words, the etchant may etch raw material that is under the photoresist. For example, where the top and bottom portions of the barrier rib are about 40 μm wide, the barrier rib's center may be about 20 μm wide. Accordingly, this biconcave barrier rib structure may interrupt the light emitting path of phosphors formed on the sides of the barrier ribs, which may decrease light emitting efficiency.

### SUMMARY OF THE INVENTION

The present invention provides a PDP that may have improved brightness and discharging characteristics by forming dual-layered barrier ribs in an etching process, and a method of fabricating the PDP.

Additional features of the invention will be set forth in the description which follows, and in part will be apparent from the description, or may be learned by practice of the invention.

The present invention discloses a method of fabricating a PDP including barrier ribs that define a plurality of discharge cells. The method includes forming a barrier rib having a multi-layered structure by performing at least two etching processes on a substrate.

The present invention also discloses a PDP including a front substrate and a rear substrate facing each other, and barrier ribs disposed between the front and rear substrates and defining a plurality of discharge cells. A barrier rib is formed of at least two layers.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A, FIG. 1B, FIG. 1C, FIG. 1D and FIG. 1E are views showing a conventional process of fabricating barrier ribs in a PDP.

FIG. 2 is a cross-sectional view showing a PDP according to an exemplary embodiment of the present invention.

FIG. 3A is a cross-sectional view showing a status after patterning an address electrode on a substrate of the present invention.

FIG. 3B is a cross-sectional view showing a status of applying a raw material for forming a first layer barrier rib on the substrate of FIG. 3A.

FIG. 3C is a cross-sectional view showing a status after coating a first photoresist on the substrate of FIG. 3B.

FIG. 3D is a cross-sectional view showing states of exposing and developing the substrate of FIG. 3C.

FIG. 3E is a cross-sectional view showing a state of etching the substrate of FIG. 3D.

FIG. 3F is a cross-sectional view showing a status after forming the first layer barrier ribs on the substrate of FIG. 3E.

FIG. 3G is a cross-sectional view showing a status after separating the first photoresist remaining on the substrate of FIG. 3F.

FIG. 3H is a cross-sectional view showing a status after coating a second photoresist between first layer barrier ribs of FIG. 3G.

FIG. 3I is a cross-sectional view showing a status after applying a raw material for forming a second layer barrier rib on the substrate shown in FIG. 3H.

FIG. 3J is a cross-sectional view showing a status after patterning the second photoresist on the substrate shown in FIG. 3I.

FIG. 3K is a cross-sectional view showing a status after forming the second layer barrier ribs on the substrate shown in FIG. 3J.

FIG. 3L is a cross-sectional view showing a status after forming barrier ribs combining the first and second layer barrier ribs on the substrate shown in FIG. 3K.

### DETAILED DESCRIPTION OF THE ILLUSTRATED EMBODIMENTS

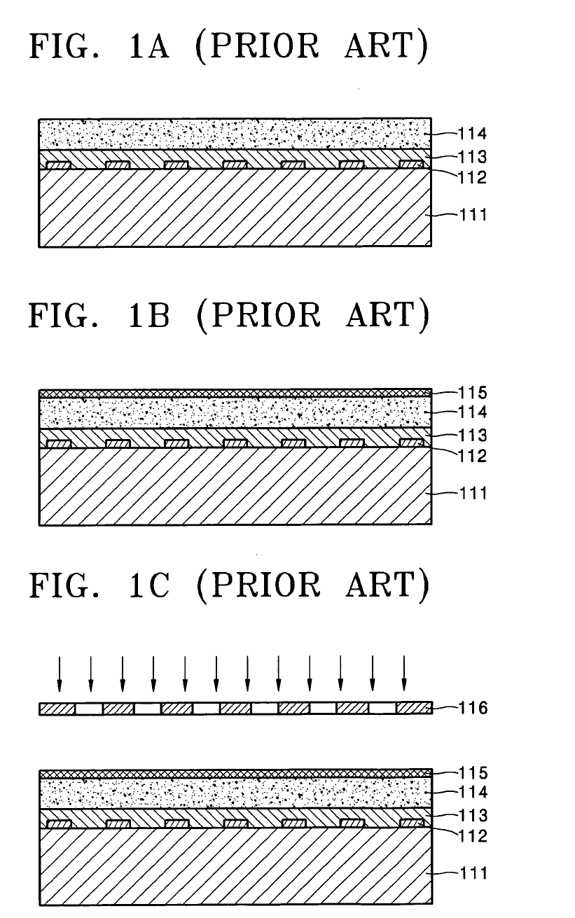

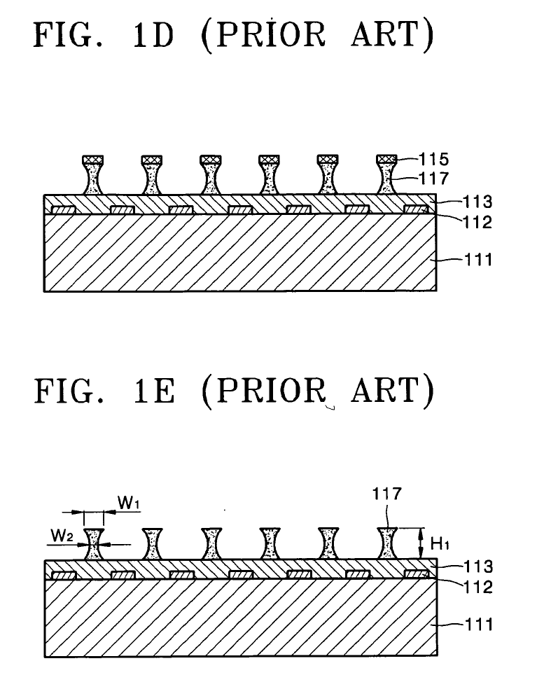

FIG. 1A, FIG. 1B, FIG. 1C, FIG. 1D and FIG. 1E are views showing a conventional process of fabricating barrier ribs in a PDP.

Referring to the drawings, address electrodes 112 are patterned on a substrate 111, a dielectric layer 113 covers the address electrodes 112, and a raw material 114 for forming the barrier ribs may be applied on the dielectric layer 113 (FIG. 1A).

Next, a photoresist 115 may be applied on the raw material 114 for forming the barrier ribs (FIG. 1B). After applying the photoresist 115, a photomask 116 may be arranged on the photoresist 115, and the photoresist 115 is exposed and developed (FIG. 1C).

Unnecessary portions of the raw material 114 may be removed to form the barrier ribs 117, which are shown as stripe-shaped in FIG. 1D. Here, the photoresist 115 may remain on the barrier ribs 117 (FIG. 1D) until it is removed, thereby completing the barrier ribs 117 (FIG. 1E).

However, the barrier rib 117 may have a biconcave cross section. Specifically, a width W₁ of the top of the barrier rib 117 may be greater than a width W₂ of the barrier rib's center. This under cut problem may be caused by an isotropic etching speed in the etching process for forming the barrier ribs 117 having a height H₁.

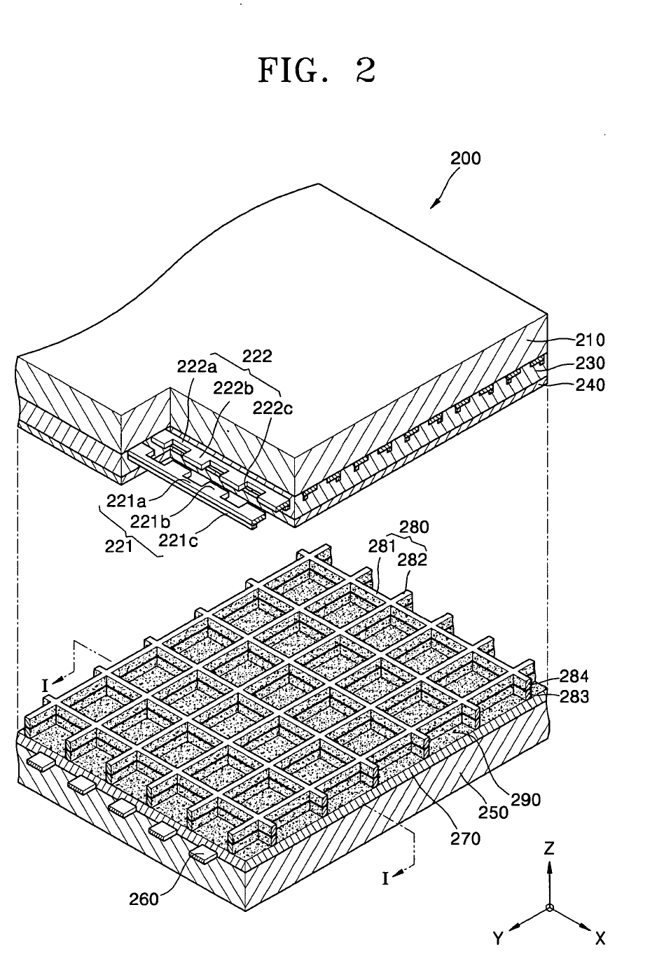

FIG. 2 is a view showing a part of a PDP 200 according to an exemplary embodiment of the present invention.

Referring to FIG. 2, the PDP 200 includes a front substrate 210 and a rear substrate 250.

The front substrate 210 may be formed of a transparent material such as, for example, a soda lime glass. Pairs of X electrodes 221 and the Y electrodes 222 may be disposed on a lower surface of the front substrate 210 along a direction X.

The X electrodes 221 may include a stripe-shaped first transparent electrode line 221a, a first protrusion 221b protruding from the first transparent electrode line 221a toward the Y electrode 222, and a first bus electrode line 221c formed along an edge of the first transparent electrode line 221a.

The Y electrodes 222 may include a stripe-shaped second transparent electrode line 222a, a second protrusion 222b protruding from the second transparent electrode line 222a toward the X electrode 221, and a second bus electrode line 222c formed along an edge of the second transparent electrode line 222a.

The first and second transparent electrode lines 221a and 222a and the first and second protrusions 221b and 222b may be formed of a transparent conductive film, such as, for example, an indium tin oxide (ITO) film. Additionally, the first and second bus electrode lines 221c and 222c may be formed of a material having high conductivity, such as, for example, an Ag paste, in order to enhance the conductivity of the first and second transparent electrode lines 221a and 222a.

A front dielectric layer 230 may cover the X and Y electrodes 221 and 222. The front dielectric layer 230 can be selectively printed onto the patterned X and Y electrodes 221 and 222, or it can be printed on the entire surface of front substrate 210. A protective layer 240, which may be made of a material such as, for example, magnesium oxide (MgO), may cover the front dielectric layer 230.

The rear substrate 250 is disposed substantially parallel to the front substrate 210. The rear substrate 250 may also be formed of a transparent material such as the soda lime glass.

Stripe-shaped address electrodes 260 may be disposed on the rear substrate 250 along a direction Y. The address electrodes 260 may be arranged to cross the X and Y electrodes 221 and 222. Further, the address electrodes 260 extend across neighboring discharge cells, and a rear dielectric layer 270 covers the address electrodes 260.

Barrier ribs 280 may be disposed between the front and rear substrates 210 and 250 to define discharge cells and prevent cross-talk between adjacent discharge cells. The barrier ribs 280 may include transverse barrier ribs 281, which are disposed along direction X, and longitudinal barrier ribs 282, which are disposed along direction Y. As FIG. 2 shows, the transverse and longitudinal barrier ribs 281 and 282 may form a matrix.

The barrier ribs 280 may be formed having various shapes, such as, for example, is a meander type, a delta type, or a honeycomb type. Hence, the discharge cells may have various shapes, such as, for example, a quadrangle, a hexagon, an oval, or a circular shape.

Phosphor layers 290 of red, green, and blue colors may be applied in the discharge cells defined by the barrier ribs 280. While the phosphor layers 290 can be applied on any portion of the discharge cell, FIG. 2 shows the phosphor layers 290 applied on an upper surface of the rear dielectric layer 270 and on sides of the barrier ribs 280.

The phosphor layer 290 may be coated on each discharge cell. For example, the red phosphor may be formed of (Y,Gd)BO₃;Eu⁺³, the green phosphor may be formed of Zn₂SiO₄:Mn²⁺, and the blue phosphor may be formed of BaMgAl₁₀O₇:Eu²⁺.

In the PDP 200 having the above structure, an address voltage may be applied between a Y electrode 222 and an address electrode 260 to select a discharge cell, and a sustain discharge voltage may be alternately applied to the X and Y electrodes 221 and 222 to cause a surface discharge on the surface of the front substrate 210 in selected discharge cells (i.e. sustain discharge). The sustain discharge generates ultraviolet rays, which excite the phosphor layer 290 of the selected discharge cell to emit visible light, thereby displaying a desired image.

According to an exemplary embodiment of the present invention, the PDP 200 may include multi-layered barrier ribs by performing at least two etching processes, thereby providing less concave barrier ribs. Additionally, the multi-layered barrier ribs may be formed to have a certain shape by two or more etching processes.

The barrier ribs according to exemplary embodiments of the present invention will be described in more detail below.

Referring to FIG. 2, the barrier ribs 280, which define discharge cells, may be formed on the rear substrate 250. The barrier ribs 280 may include a first layer barrier rib 283, which may be directly patterned on the surface of the rear dielectric layer 270, and a second layer barrier rib 284, which may be formed on an upper portion of the first layer barrier rib 283. The second layer barrier rib 284 may be integrally formed on the upper portion of the first layer barrier ribs 283, and it may have the same shape as that of the first layer barrier rib 283. Accordingly, the first and second layer barrier ribs 283 and 284 form a dual-layered structure. Additionally, cross sectional areas of upper and lower portions of the first and second barrier ribs 283 and 284 may be relatively wider than that of the center portions due to the etching process.

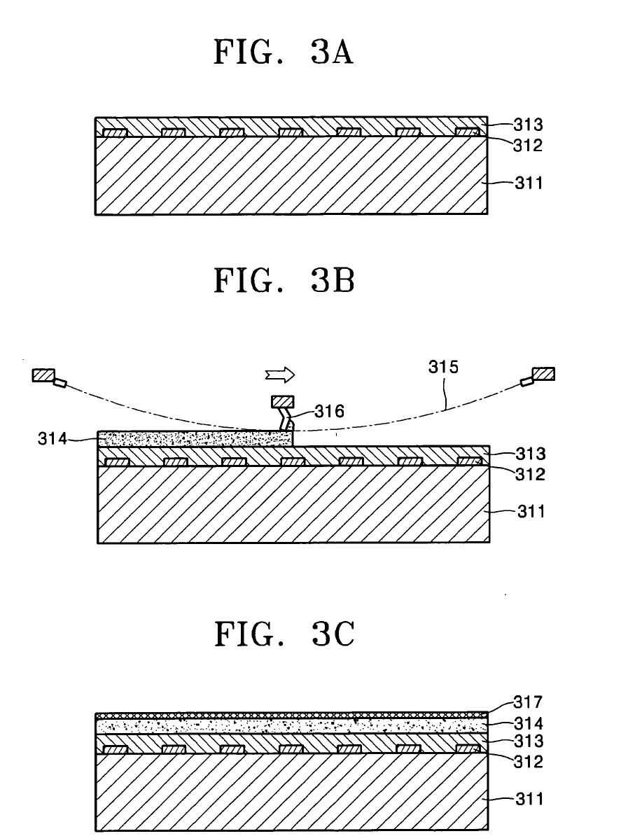

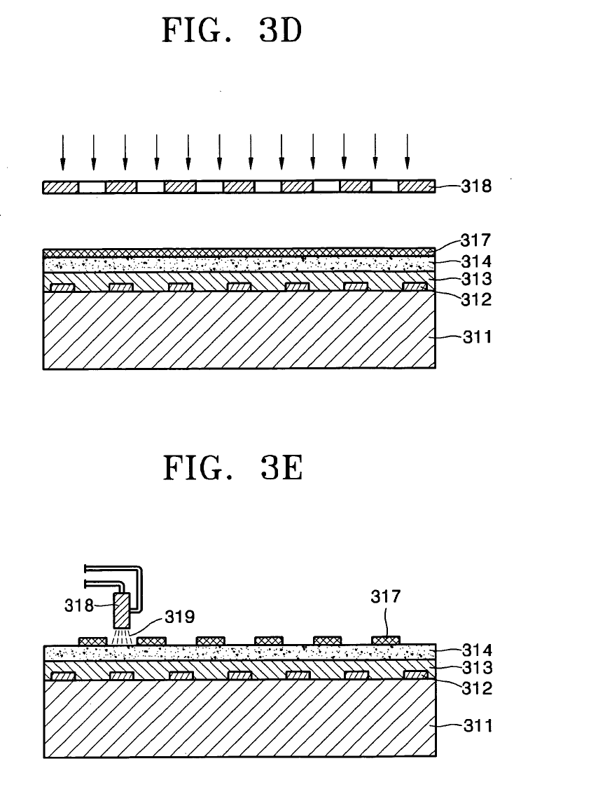

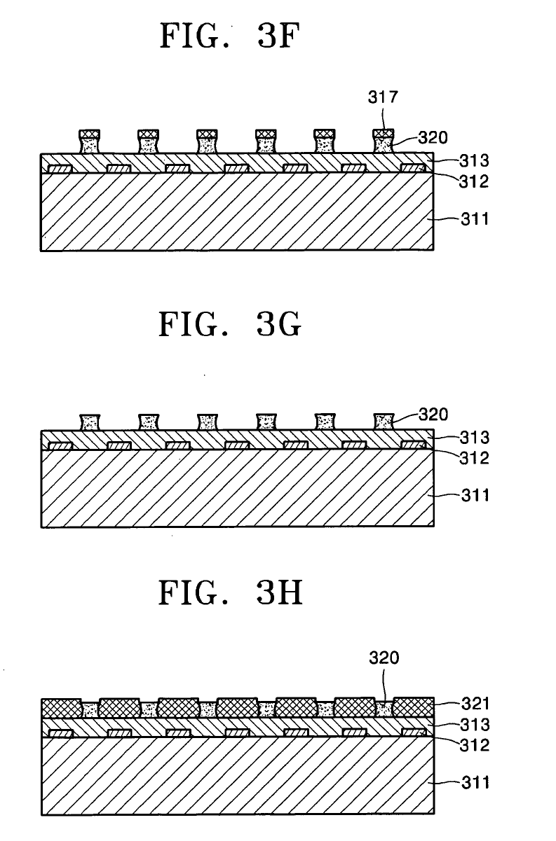

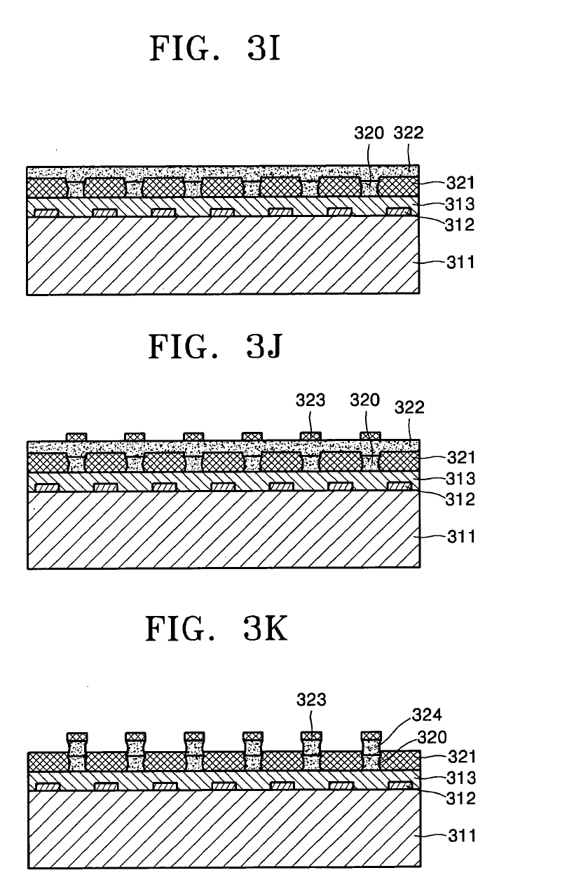

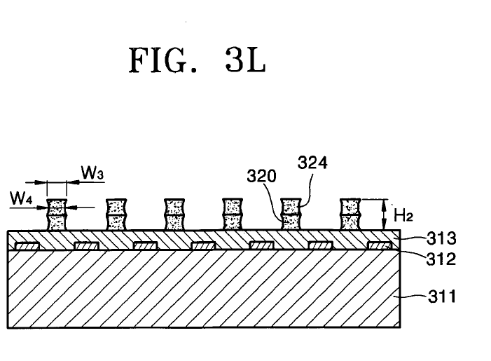

Hereinafter, processes for fabricating the barrier ribs according to exemplary embodiments of the present invention will be described with reference to FIG. 3A, FIG. 3B, FIG. 3C, FIG. 3D, FIG. 3E, FIG. 3F, FIG. 3G, FIG. 3H, FIG. 3I, FIG. 3J, FIG. 3K and FIG. 3L.

As shown in FIG. 3A, a substrate 311, which may be formed of a transparent material, such as, for example, glass is prepared. Address electrodes 312 may be printed on the substrate 311 and baked. The address electrodes 312 may be disposed in a certain direction on the substrate 311 and be separated by a predetermined interval from each other. A dielectric layer 313 may be coated on the address electrodes 312 to cover the address electrodes 312.

Additionally, as shown in FIG. 3B, a raw material 314 for forming a first layer barrier rib may be printed on the rear substrate 311. The raw material 314 for forming the first layer barrier rib can be coated in various ways. FIG. 3B shows the raw material 314 mounted on a screen 315, and a squeegee 316 proceeds along the substrate 311 to perform the entire printing operation.

As FIG. 3C shows, a first photoresist 317 may be applied on the raw material 314 for forming the first layer barrier rib.

A photomask 318 may then be aligned above the first photoresist 317, as shown in FIG. 3D, and exposure and development processes may be performed by irradiating ultraviolet rays onto the substrate.

Accordingly, as shown in FIG. 3E, the first photoresist 317 may remain on the portions of the raw material 314 corresponding to the barrier ribs that will be formed, while other portions of the first photoresist 317 are removed.

Next, an etchant 319 may be injected on the upper portion of the rear substrate 311 through a nozzle 318 to wash away the raw material 314 exposed by the first photoresist 317, thereby forming the first layer barrier ribs 320, as shown in FIG. 3F. The first layer barrier ribs 320 are formed through a first etching process using the etchant's isotropic etching speed, which may be the same in vertical and horizontal directions.

Next, as FIG. 3G shows, the remaining first photoresist 317 may be removed, thereby completing the first layer barrier ribs 320. The cross sectional areas of upper and lower portions of the first layer barrier ribs 320 may be larger than that of the center portion due to the etching process, thereby forming the barrier rib 320 in an “I”-like shape.

After forming the first layer barrier ribs 320, a second photoresist 321 may be applied onto spaces between the first layer barrier ribs 320, as shown in FIG. 3H, and then patterned by exposure and development. Since the second photoresist 321 is about 30 μm thick, the second photoresist 321 may block the empty spaces rather than infiltrating into the empty spaces.

As FIG. 3I shows, a raw material 322 for forming a second layer barrier rib may be printed on the first layer barrier ribs 320 and the second photoresist 321.

After applying the raw material 322 for forming the second layer barrier rib, a third photoresist 323 may be applied onto the raw material 322, as shown in FIG. 3J. The third photoresist 323 may then be patterned by exposing and developing using the photomask as described above.

As FIG. 3K shows, the etchant may be injected through a nozzle onto the upper portion of the rear substrate 311 to perform a second etching process. According to the isotropic etching speed in vertical and horizontal directions, the second layer barrier ribs 324 are formed on the upper portion of the first layer barrier ribs 320. Additionally, the second layer barrier ribs 324 may have similar shapes as the first layer barrier ribs 320.

As FIG. 3L shows, the remaining third photoresist 323, which is on the upper portion of the second layer barrier ribs 324, and the remaining second photoresist 321, which is between the first layer barrier ribs 320, may be removed, thereby completing the second layer barrier ribs 324.

The first and second layer barrier ribs 320 and 324 formed by the first and second etching processes form a dual-layered structure. The barrier ribs are not limited to the dual-layered structure. Rather, the barrier ribs may comprise any multiple-layered structure formed through two or more etching processes. Additionally, the total height H₂ of the first and second layer barrier ribs 320 and 324 may be the same as the height H₁ of the conventional barrier rib (117 of FIG. 1E).

Accordingly, forming the barrier ribs 320 and 324 with at least two etching processes reduces the undercut problem caused during the etching process. As FIG. 3L shows, a width W₄ of a center portion of the second layer barrier rib 324 may be wider than in the conventional barrier rib as compared to a width W₃ of the upper portion of the second layer barrier rib 324. Since the first and second layer barrier ribs 320 and 324 are individually formed thinner than the conventional barrier rib, the amount of decreased width at the barrier rib's center may be reduced relatively.

Table 1 shows results of experiments carried out with a PDP formed according to an exemplary embodiment of the present invention.

TABLE 1

| | Comparative | | | |
|---|---|---|---|---|
| | example | Example | Difference | Improved rate |
| F/W brightness | l74 cd/m² | 201 cd/m² | 27 cd/m² | 15.5% |
| Light emitting | 1.07 lu/w | 1.17 lu/w | 0.1 lu/w | 9.34% |
| efficiency | | | | |

The Example denotes a PDP having a dual-layered barrier rib structure formed through first and second etching processes, as shown in FIG. 3A through FIG. 3L. The comparative example denotes a PDP having barrier ribs of a single-layer structure fabricated using a conventional method. In addition, full color (F/W) brightness of panel assemblies and light emitting efficiencies were measured.

Referring to Table 1, the F/W brightness of the PDP according to the present invention was 201 cd/m² and the F/W brightness of the comparative example was 174 cd/m², resulting in a difference about 27 cd/m², which is an improvement of about 15.5%. Additionally, in the PDP of the present invention, the light emitting efficiency was 1.17 lu/w, however, the light emitting efficiency of the comparative example was 1.07 lu/w, resulting in a difference about 0.1 lu/w, which is an improvement of about 9.34%.

Since the barrier ribs are fabricated through multiple etching processes, each barrier rib layer is thinner than the conventional barrier rib. Therefore, horizontal undercutting of each barrier rib layer under the photoresist, due to the isotropic etching speed, may be reduced during etching. Thus, discharge characteristics may be improved.

As described above, according to embodiments of the present invention, since the barrier ribs are formed in a multi-layered structure using two or more etching processes, the barrier ribs may be formed straighter (i.e. less concave).

Additionally, since straighter barrier ribs may block less light, the brightness and light emitting efficiency can be improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of fabricating a plasma display panel including barrier ribs that define a plurality of discharge cells, comprising:
forming a barrier rib having a multi-layered structure by performing at least two etching processes on a substrate.

2. The method of claim 1, wherein forming the barrier rib having the multi-layered structure comprises forming a first layer barrier rib on the substrate by a first etching process and forming a second layer barrier rib on the first layer barrier rib by a second etching process.

3. The method of claim 2, wherein forming the first layer barrier rib comprises:
applying a raw material for forming the first layer barrier rib on the substrate;
applying a first photoresist on the raw material for forming the first layer barrier rib;
exposing and developing the first photoresist;
etching the raw material for forming the first layer barrier rib; and
removing portions of the first photoresist remaining on the first layer barrier rib.

4. The method of claim 3, further comprising patterning a second photoresist between adjacent first layer barrier ribs before forming the second layer barrier rib.

5. The method of claim 4, wherein forming the second layer barrier rib comprises:
applying a raw material for forming the second layer barrier rib on the first layer barrier rib and the second photoresist;
applying a third photoresist on the raw material for forming the second layer barrier rib;
exposing and developing the third photoresist;
etching the raw material for forming the second layer barrier rib; and
removing the second photoresist and portions of the third photoresist remaining on the second layer barrier rib.

6. The method of claim 5, wherein the second layer barrier rib has the same shape as the first layer barrier rib.

7. The method of claim 5, wherein the second layer barrier rib is integrally coupled to the first layer barrier rib.

8. A plasma display panel (PDP), comprising:
a front substrate and a rear substrate facing each other;
barrier ribs disposed between the front substrate and the rear substrate and defining a plurality of discharge cells,
wherein a barrier rib is formed of at least two layers.

9. The PDP of claim 8, wherein upper and lower portions of a barrier rib layer are wider than a center portion of the barrier rib layer.
